(19) United States
(12) Patent Application Publication
(10) Pub. No.: US 2026/0262692 A1
(43) Pub. Date: Sep. 10, 2026

(54) BULK SWEETENER SYSTEMS FOR CONFECTIONS

(71) Applicant: Wm. Wrigley Jr. Company, Chicago, IL (US)

(72) Inventor: Heather MENDENHALL, Evanston, IL (US)

(73) Assignee: Wm. Wrigley Jr. Company, Chicago, IL (US)

(21) Appl. No.: 19/164,717

(22) PCT Filed: Mar. 15, 2024
(86) PCT No.: PCT/US2024/020169

§ 371 Date: Sep. 12, 2025

Related U.S. Application Data
(60) Provisional application No. 63/452,341, filed on Mar. 15, 2023.

(51) Int. Cl. A23L 27/30; A23G 3/42; A23L 29/30

(52) U.S. Cl. CPC A23L 27/33; A23G 3/42; A23L 29/35

(57) ABSTRACT

Bulk sweetener compositions and reduced sugar confections are described. The bulk sweetener composition may include at least one of a glucose syrup, a soluble fiber, and maltodextrin; and at least one of a monosaccharide, a disaccharide, and a low calorie monosaccharide. The bulk sweetener composition may provide for at least 33% sugar reduction in a confectionery product.

### CROSS-REFERENCE TO RELATED APPLICATIONS

This application claims priority to U.S. Provisional Application No. 63/452,341, filed on Mar. 15, 2023, which is incorporated by reference herein in its entirety.

### TECHNICAL FIELD

The present disclosure generally relates to bulk sweetener compositions and reduced sugar confections. The bulk sweetener compositions may be suitable for replacing traditional sucrose and corn syrup mixtures in a variety of confections to reduce the sugar content thereof.

### BACKGROUND

Various confectionery products comprise a combination of sugar (e.g., sucrose) and corn syrup. The sugar within the mixture provides bulking (e.g., structure), water binding, hygroscopicity and sweetness, while the corn syrup contributes to providing viscosity and aids in inhibiting crystallization. Some traditional confections, such as gelled candies, have been made with corn syrup and sucrose in a ratio of 55:45 wt. % solids. However, consumers are becoming more interested in confections that have lower amounts of sucrose.

In recent years, efforts have been devoted to replace sugar and corn syrups normally found in confectionery products with other carbohydrates and non-carbohydrates. For example, polyols, such as sorbitol, erythritol, maltitol, and xylitol, have been used. A disadvantage of polyols is that they may cause gastrointestinal disturbance (e.g., laxation). Both artificial and natural high intensity sweeteners, such as, for example, aspartame, sucralose, acesulfame-K, and stevia have also been used. However, high intensity sweeteners offer no bulk. Certain high intensity sweeteners may provide a bitter aftertaste. There is also a growing consumer demand for products derived from natural ingredients, thus rendering artificial sweeteners less desirable. Another challenge in replacing traditional sugar and corn syrup blends is maintaining acceptable taste, texture, stability, and colligative properties.

Therefore, there is a growing interest in being able to replace traditional sucrose and corn syrup blends in a variety of confections in order to reduce the sugar content, while providing taste, texture, and colligative properties that are comparable to the traditional blends, without the use of polyols and high intensity sweeteners.

### SUMMARY

The present disclosure includes bulk sweetener compositions and reduced sugar confections comprising the bulk sweetener compositions. For example, the present disclosure includes a bulk sweetener composition. The bulk sweetener composition may comprise at least one of a glucose syrup, a soluble fiber, and maltodextrin. The bulk sweetener composition may further comprise at least one of a monosaccharide, a disaccharide, and a low calorie monosaccharide. In some aspects of the present disclosure, the bulk sweetener composition does not comprise a polyol or a high intensity sweetener.

In some examples, the bulk sweetener composition may comprise a glucose syrup in an amount from about 0% to about 53% by weight, based on the total weight of the bulk sweetener composition; a disaccharide in an amount form about 25% to about 47% by weight, based on the total weight of the bulk sweetener composition; and a low calorie monosaccharide in an amount from about 0% to about 12% by weight, based on the total weight of the bulk sweetener composition. The low calorie monosaccharide may be allulose.

In some examples, the bulk sweetener composition may further comprise maltodextrin in an amount from about 0% to about 12% by weight, based on the total weight of the bulk sweetener composition. In some examples, the bulk sweetener composition may further comprise a soluble fiber in an amount from about 0% to about 10% by weight, based on the total weight of the bulk sweetener composition. For example, the soluble fiber may be resistant maltodextrin.

The present disclosure also includes a confectionery composition comprising a bulk sweetener composition. The bulk sweetener composition may comprise at least one of a glucose syrup, a soluble fiber, and maltodextrin. The bulk sweetener composition may further comprise at least one of a monosaccharide, a disaccharide, and a low calorie monosaccharide. The bulk sweetener composition may provide for at least 33% sugar reduction in the confectionery composition. In some examples, the bulk sweetener composition further comprises water. In some examples, the bulk sweetener composition may be free from polyols.

According to some aspects of the present disclosure, the low calorie monosaccharide is allulose, tagatose, or a combination thereof. In some examples, the disaccharide is sucrose, maltose, lactose, trehalose, or a combination thereof. In at least one example, the monosaccharide is fructose, glucose, or a combination thereof.

In some examples, the bulk sweetener composition may comprise soluble fiber. The soluble fiber may be a resistant maltodextrin. In at least one example, the glucose syrup is a high maltose corn syrup. In some aspects of the present disclosure, the bulk sweetener composition may comprise soluble fiber, glucose syrup, a monosaccharide, and a disaccharide. In some examples, the bulk sweetener composition may comprise glucose syrup, maltodextrin, a monosaccharide, and a disaccharide.

The confectionery composition as described above may be selected from gelled, chewy, and hard candies. In some examples, the bulk sweetener composition may provide for at least 50% sugar reduction in the confectionery composition.

The present disclosure also includes a reduced sugar gelled confection. The reduced sugar gelled confection may comprise a gelling agent comprising gelatin, pectin, starch, hydrocolloids, or combinations thereof. The reduced sugar gelled confection may also comprise a bulk sweetener composition. The bulk sweetener composition may comprise at least one of a glucose syrup, a soluble fiber, and maltodextrin; and at least one of a monosaccharide, a disaccharide, and a low calorie monosaccharide selected from allulose and tagatose. The reduced sugar gelled confection may be free from polyols. The reduced sugar gelled confection may have a texture similar to that of a gelled confection comprising corn syrup to sucrose at a ratio of 55:45 wt. % solids. In some examples, the bulk sweetener composition may comprise a monosaccharide in the form of fructose and a disaccharide in the form of sucrose.

In at least one example, the bulk sweetener composition comprises allulose and a disaccharide in the form of sucrose. In some examples, the gelling agent is pectin. In other examples, the gelling agent is gelatin. In some aspects of the present disclosure, the gelled confection is free from high intensity sweeteners. In some examples, the reduced sugar gelled confection may include 12 grams or less of sugar per 30 gram serving.

### DETAILED DESCRIPTION

Particular aspects of the present disclosure are described in greater detail below. The terms and definitions provided herein control, if in conflict with terms and/or definitions incorporated by reference.

As used herein, the terms “comprises,” “comprising,” or any other variation thereof are intended to cover a non-exclusive inclusion, such that a process, method, composition, article, or apparatus that comprises a list of elements does not include only those elements, but may include other elements not expressly listed or inherent to such process, method, composition, article, or apparatus. The term “exemplary” is used in the sense of “example” rather than “ideal.” As used herein, the singular forms “a,” “an,” and “the” include plural reference unless the context dictates otherwise. Relative terms such as “about,” “substantially,” and “approximately” refer to being nearly the same as a referenced number or value, and should be understood to encompass a variation of ±5% of a specified amount or value.

All percentages and ratios used herein are by weight of the total composition.

The present disclosure relates to bulk sweetener compositions and reduced sugar confections. The bulk sweetener compositions may be used to replace traditional sucrose and corn syrup mixtures in a variety of confections to provide a reduced sugar content. The bulk sweetener compositions of the present disclosure may include various combinations of carbohydrates. Exemplary bulk sweetener compositions may be in the form of a syrup. For example, a bulk sweetener composition disclosed herein may also be referred to as a bulk phase replacement syrup.

Bulk sweetener compositions according to the present disclosure may include at least one of a glucose syrup, a soluble fiber, and maltodextrin. In some examples, the bulk sweetener composition may include at least one of a glucose syrup and a soluble fiber. In at least one example, the bulk sweetener composition may be free from maltodextrin. The bulk sweetener compositions may further include at least one of a monosaccharide, a disaccharide, and a low calorie monosaccharide. In some examples, the bulk sweetener compositions may also include water. In other examples, a bulk sweetener composition of the present disclosure may be free from added water. Each of the carbohydrates in the bulk sweetener composition may contribute to the bulk and/or sweetness of the composition.

Carbohydrates in the bulk sweetener compositions of the present disclosure may be classified in groups based on their molecular weights. For example, a bulk sweetener composition may include a high molecular weight fiber, such as, for example, polydextrose, fructo-oligosacchrides, oligofructose, inulin, isomalto-oligosaccharides, mannan-oligosaccharides, galacto-oligosaccharides, xylo-oligosaccharides and resistant maltodextrin. High molecular weight fibers herein may have an average molecular weight greater than that of sucrose. A bulk sweetener composition may also include low molecular weight sugars. Low molecular weight sugars may include monosaccharides and disaccharides.

Table 1 includes the average molecular weights of various carbohydrates, including suitable ingredients which may be used in bulk sweetener compositions of the present disclosure.

TABLE 1

| | Average Molecular |
|---|---|
| Ingredient | weight (g/mol) |
| Monosaccharides (Fructose, glucose, | 180 |
| allulose, tagatose) | |
| Disaccharides (Sucrose, lactose, | 342 |
| maltose, trehalose) | |
| 63 DE Corn Syrup | 385 |
| High Maltose 42 DE Corn Syrup | 476 |
| 42 DE Corn Syrup | 516 |
| Resistant Maltodextrin | 1700-6000 |
| (soluble fiber syrups) | |
| Polydextrose | 2000 |
| Maltodextrin (10 DE) | 15000 |
| Starch | 1100000 |

In some embodiments, the bulk sweetener composition may include a glucose syrup such as corn syrup and high maltose corn syrup. The glucose syrup may be derived from corn, rice, wheat, potatoes, barley, and cassava. The glucose syrup or corn syrup may have a dextrose equivalent (“DE”) ranging from about 40 to about 63. In some embodiments of the present disclosure, the glucose syrup does not include high fructose corn syrups (having DE ranging from about 52-97).

Bulk sweetener compositions disclosed herein may include one or more dietary fibers. A variety of fibers (e.g., dietary fibers) may be used in the bulk sweetener compositions to replace certain properties provided by corn syrup in traditional mixtures. Dietary fiber may include soluble fiber, non-digestible fiber, or insoluble fiber. In some examples, the bulk sweetener composition may include a soluble fiber. For example, the bulk sweetener composition may include a soluble fiber syrup. Exemplary soluble fiber syrups include soluble corn fiber, resistant maltodextrin, inulin, polydextrose, beta-glucan, soluble wheat or corn dextrin (e.g, Nutriose®), and Promitor®. In some examples, a soluble fiber may include a high molecular weight resistant dextrin with an average molecular weight between about 4,000 g/mol and about 6000 g/mol or a low molecular weight resistant dextrin with an average molecular weight between about 1,500 g/mol and about 4,000 g/mol. Dietary fibers may be included to provide bulk. Soluble fiber may comprise a high molecular weight resistant dextrin with average molecular weight between 4000-6000 g/mol or a low molecular weight resistant dextrin with average molecular weight 1,500-4000 g/mol.

A bulk sweetener composition of the present disclosure may also include maltodextrin. The maltodextrin may be included to provide bulk. Maltodextrins of the present disclosure may have a DE ranging from about 3 to about 20. For example, maltodextrin may have a DE from about 5 to about 10 or from about 10 to about 20.

Bulk sweetener compositions disclosed herein may also include saccharides. For example, a bulk sweetener composition may include disaccharides. In some embodiments, the bulk sweetener composition may further include a monosaccharide and/or a low calorie monosaccharide. Exemplary disaccharides include sucrose (sugar), maltose, lactose, trehalose, and cellobiose. Bulk sweetener compositions comprising a monosaccharide may include glucose or fructose. Low calorie monosaccharides may include allulose and tagatose. Other rare sugars (e.g., sorbose and allose) may also be included. In some embodiments, the monosaccharides and/or disaccharides may be provided through other ingredients in the bulk sweetener composition, such as, for example, a glucose syrup or a corn syrup. The smaller molecular weight sugars (e.g., monosaccharides and/or disaccharides) may be included to provide crystallization and humectancy. The smaller molecular weight sugars may also be used to lower water activity. For example, a smaller molecular weight sugar may be used to lower water activity from a water activity value of about 0.7 to a water activity value of about 0.5.

The bulk sweetener compositions of the present disclosure may comprise various combinations of the carbohydrates discussed herein. In one example, a bulk sweetener composition may include soluble fiber, maltodextrin, a low calorie monosaccharide, and a disaccharide. For example, the bulk sweetener composition may include resistant maltodextrin, maltodextrin, allulose, and sucrose. In another example, a bulk sweetener composition may include a glucose syrup, soluble fiber syrup, a monosaccharide, and a disaccharide. For example, the bulk sweetener composition may include high maltose corn syrup, resistant maltodextrin, fructose, and sucrose. A bulk sweetener composition of the present disclosure may also include two or more carbohydrates from the same category. For example, a bulk sweetener composition may comprise fructose and glucose.

Bulk sweetener compositions disclosed herein may be formulated based on the properties of each carbohydrate component in the bulk sweetener composition. For example, in a bulk sweetener composition comprising soluble fiber syrup and monosaccharides and/or disaccharides, the monosaccharides and/or disaccharides may be added in certain amounts to manipulate desired properties of the soluble fiber. In some examples, the concentration of an ingredient such as a soluble fiber may be increased based on the desired viscosity of the bulk sweetener composition. In other examples, the amount of smaller molecular weight sugars may be increased to raise the glass transition temperature. The ratios of high molecular weight fibers to smaller molecular weight sugars in bulk sweetener compositions herein may provide for a desirable glass transition temperature. In some embodiments, the bulk sweetener composition may impart texture in a confection that is similar to the texture of confections based on traditional corn syrup and sucrose mixtures at a ratio of 55:45 wt. % solids.

The ratios between the carbohydrates in the bulk sweetener compositions of the present disclosure are largely dependent on desired sugar reduction in confections. Some embodiments herein may provide for up to 90% sugar reduction in various confections. In some examples, the sugar (e.g., sucrose) in a confection comprising the bulk sweetener composition may be reduced by at least 25%, by at least 30%, by at least 35%, by at least 40%, by at least 50%, by at least 60%, by at least 70%, by at least 75%, by at least 80%, by at least 85%, by at least 90%, or by at least 95%. In some examples, a confection comprising the bulk sweetener composition may comprise less than 50 wt % sugar.

In some aspects of the present disclosure, the sugar content of a reduced sugar confection may range from about 0.5 grams to about 13 grams per 30 gram serving. For example, the sugar content of a reduced sugar confection may range from 1 gram to 5 grams per 30 gram serving, from 2 grams to 3 grams per 30 gram serving, from 4 grams to 6 grams per 30 gram serving, from 7 grams to 9 grams per 30 gram serving, or from 10 grams to 12 grams per 30 gram serving. In some examples, the sugar content of a reduced sugar confection may be less than 0.5 grams per 30 gram serving.

By way of example, a bulk sweetener composition for providing 13 g of sugar per 30 g serving according to the present disclosure may comprise the following ingredients

TABLE 2
Bulk Phase Sugar Replacement (13 g sugar per 30 g serving)

| Component | Lower | Upper |
|---|---|---|
| CORN SYRUP (42 to 63 DE) | 0.00% | 53.00% |
| MALTODEXTRIN | 0.00% | 12.00% |
| RESISTANT MALTODEXTRIN | 0.00% | 10.00% |
| LOW CALORIE MONOSACCHARIDES | | |
| (ALLULOSE, TAGATOSE) | 0.00% | 12.00% |
| MONOSACCHARIDES (FRUCTOSE, GLUCOSE) | 0.00% | 6.00% |
| DISACCHARIDES (SUCROSE, MALTOSE, | | |
| LACTOSE, TREHALOSE) | 25.00% | 47.00% |
| WATER | 15.00% | 20.00% |

Various combinations of the components and their respective ranges as specified in Table 2 for a bulk sweetener composition of the present disclosure, may reduce approximately 20 g of sugar per 30 g serving in a confection to 13 g sugar per 30 g serving to achieve a 33% reduction in sugar.

By way of example, a bulk sweetener composition for providing 10 g of sugar per 30 g serving according to the present disclosure may comprise the following ingredients:

TABLE 3
Bulk Phase Sugar Replacement (10 g sugar per 30 g serving)

| Component | Lower | Upper |
|---|---|---|
| CORN SYRUP (42 to 63 DE) | 0.00% | 45.00% |
| MALTODEXTRIN | 0.00% | 14.00% |
| RESISTANT MALTODEXTRIN | 0.00% | 24.00% |
| LOW CALORIE MONOSACCHARIDES | | |
| (ALLULOSE, TAGATOSE) | 0.00% | 23.00% |
| MONOSACHARRIDES (FRUCTOSE, GLUCOSE) | 0.00% | 5.00% |
| DISACCHARIDES (SUCROSE, MALTOSE, | | |
| LACTOSE, TREHALOSE) | 5.00% | 13.00% |
| WATER | 15.00% | 20.00% |

Various combinations of the components and their respective ranges as specified in Table 3 for a bulk sweetener composition of the present disclosure, may reduce approximately 20 g of sugar per 30 g serving in a confection to 10 g sugar per 30 g serving to achieve a 50% reduction in sugar.

By way of example, a bulk sweetener composition for providing 7 g of sugar per 30 g serving according to the present disclosure may comprise the following ingredients:

TABLE 4
Bulk Phase Sugar Replacement (7 g sugar per 30 g serving)

| Component | Lower | Upper |
|---|---|---|
| CORN SYRUP (42 to 63 DE) | 0.00% | 20.00% |
| MALTODEXTRIN | 0.00% | 14.00% |
| RESISTANT MALTODEXTRIN | 0.00% | 55.00% |
| LOW CALORIE MONOSACCHARIDES | | |
| (ALLULOSE, TAGATOSE) | 0.00% | 23.00% |
| MONOSACHARRIDES (FRUCTOSE, GLUCOSE) | 0.00% | 5.00% |
| DISACCHARIDES (SUCROSE, MALTOSE, | | |
| LACTOSE, TREHALOSE) | 5.00% | 13.00% |
| WATER | 15.00% | 20.00% |

Various combinations of the components and their respective ranges as specified in Table 4 for a bulk sweetener composition of the present disclosure, may reduce approximately 20 g of sugar per 30 g serving in a confection to 7 g sugar per 30 g serving to achieve at least 60% reduction in sugar.

By way of example, a bulk sweetener composition for providing 5 g of sugar per 30 g serving according to the present disclosure may comprise the following ingredients:

TABLE 5
Bulk Phase Sugar Replacement(5 g sugar per 30 g serving)

| Component | Lower | Upper |
|---|---|---|
| MALTODEXTRIN | 0.00% | 14.00% |
| RESISTANT MALTODEXTRIN | 0.00% | 30.00% |
| LOW CALORIE MONOSACCHARIDES | 0.00% | 25.00% |
| (ALLULOSE, TAGATOSE) | | |
| MONOSACHARRIDES (FRUCTOSE, GLUCOSE) | 0.00% | 5.00% |
| DISACCHARIDES (SUCROSE, MALTOSE, | | |
| LACTOSE, TREHALOSE) | 0.00% | 13.00% |
| WATER | 15.00% | 20.00% |

Various combinations of the components and their respective ranges as specified in Table 5 for a bulk sweetener composition of the present disclosure, may reduce approximately 20 g of sugar per 30 g serving in a confection to 5 g sugar per 30 g serving to achieve a 75% reduction in sugar.

By way of example, a bulk sweetener composition for providing from 10 g to 12 g of sugar per 30 g serving according to the present disclosure may comprise the following ingredients:

TABLE 6
Bulk Phase Sugar Replacement (10
g to 12 g sugar per 30 g serving)

| Component | Lower | Upper |
|---|---|---|
| CORN SYRUP (42 to 63 DE) | 0.00% | 10.00% |
| SOLUBLE FIBER | 13.00% | 42.00% |
| LOW-CALORIE MONOSACCHARIDES | 0.00% | 25.00% |
| (ALLULOSE, TAGATOSE) | | |
| MONOSACCHARIDES (FRUCTOSE, GLUCOSE) | 1.25% | 5.00% |
| DISACCHARIDES (SUCROSE, MALTOSE, | 25.00% | 40.00% |
| LACTOSE, TREHALOSE) | | |

Various combinations of the components and their respective ranges as specified in Table 6 for a bulk sweetener composition of the present disclosure, may reduce approximately 20 g of sugar per 30 g serving in a confection to 10 g to 12 g of sugar per 30 g serving to achieve approximately 40% to 50% reduction in sugar.

By way of example, a bulk sweetener composition for providing from 7 g to 9 g of sugar per 30 g serving according to the present disclosure may comprise the following ingredients:

TABLE 7
Bulk Phase Sugar Replacement (7 g to 9 g sugar per 30 g serving)

| Component | Lower | Upper |
|---|---|---|
| CORN SYRUP (42 to 63 DE) | 0.00% | 10.00% |
| SOLUBLE FIBER | 35.00% | 65.00% |
| LOW-CALORIE MONOSACCHARIDES | 0.00% | 25.00% |
| (ALLULOSE, TAGATOSE) | | |
| MONOSACCHARIDES (FRUCTOSE, GLUCOSE) | 0.00% | 6.00% |
| DISACCHARIDES (SUCROSE, MALTOSE, | 25.00% | 31.00% |
| LACTOSE, TREHALOSE) | | |

Various combinations of the components and their respective ranges as specified in Table 7 for a bulk sweetener composition of the present disclosure, may reduce approximately 20 g of sugar per 30 g serving in a confection to 7 g to 9 g of sugar per 30 g serving to achieve at least about 55% reduction in sugar, such as from about 55% to about 65% reduction in sugar.

By way of example, a bulk sweetener composition for providing from 4 g to 6 g of sugar per 30 g serving according to the present disclosure may comprise the following ingredients:

TABLE 8
Bulk Phase Sugar Replacement (4 g to 6 g sugar per 30 g serving)

| Component | Lower | Upper |
|---|---|---|
| SOLUBLE FIBER | 30.00% | 70.00% |
| LOW-CALORIE MONOSACCHARIDES | 0.00% | 25.00% |
| (ALLULOSE, TAGATOSE) | | |
| MONOSACHARRIDES (FRUCTOSE, GLUCOSE) | 0.00% | 5.00% |
| DISACCHARIDES (SUCROSE, MALTOSE, | 10.00% | 20.00% |
| LACTOSE, TREHALOSE) | | |

Various combinations of the components and their respective ranges as specified in Table 8 for a bulk sweetener composition of the present disclosure, may reduce approximately 20 g of sugar per 30 g serving in a confection to 4 g to 6 g sugar per 30 g serving to achieve at least about 70% reduction in sugar, such as from about 70% to about 80% reduction in sugar.

By way of example, a bulk sweetener composition for providing from 2 g to 3 g of sugar per 30 g serving according to the present disclosure may comprise the following ingredients:

TABLE 9
Bulk Phase Sugar Replacement (2 g to 3 g sugar per 30 g serving)

| Component | Lower | Upper |
|---|---|---|
| SOLUBLE FIBER | 50.00% | 75.00% |
| LOW-CALORIE MONOSACCHARIDES | 0.00% | 25.00% |
| (ALLULOSE, TAGATOSE) | | |
| MONOSACHARRIDES (FRUCTOSE, GLUCOSE) | 0.00% | 5.00% |
| DISACCHARIDES (SUCROSE, MALTOSE, | 0.00% | 10.00% |
| LACTOSE, TREHALOSE) | | |

Various combinations of the components and their respective ranges as specified in Table 9 for a bulk sweetener composition of the present disclosure, may reduce approximately 20 g of sugar per 30 g serving in a confection to 2 g to 3 g sugar per 30 g serving to achieve at least about 85% reduction in sugar, such as from about 85% to about 90% reduction in sugar.

By way of example, a bulk sweetener composition for providing less than 0.5 g of sugar per 30 g serving according to the present disclosure may comprise the following ingredients:

TABLE 10
Bulk Phase Sugar Replacement (<0.5 g sugar per 30 g serving)

| Component | Lower | Upper |
|---|---|---|
| RESISTANT MALTODEXTRIN | 50.00% | 80.00% |
| LOW-CALORIE MONOSACCHARIDES | 0.00% | 25.00% |
| (ALLULOSE, TAGATOSE) | | |

Various combinations of the components and their respective ranges as specified in Table 10 for a bulk sweetener composition of the present disclosure, may reduce approximately 20 g of sugar per 30 g serving in a confection to less than 0.5 g sugar per 30 g serving to achieve at least about 98% reduction in sugar.

In some examples herein, the concentration of monosaccharides and/or disaccharides in a bulk sweetener composition may also be provided through other ingredients such as corn syrup, maltodextrin, and/or fruit ingredients.

The bulk sweetener compositions (e.g., bulk replacement compositions or bulk phase replacement syrups) of the present disclosure may be used in a variety of confectionery products to reduce the sugar content. The confectionery products may include soft confections, such as chewy confections (nougats, soft caramels, toffee, taffy etc.) and gelled confections (e.g., gummies, jellies, gum drops). In some examples, the soft confections may be aerated. Exemplary aerated confections may include, but are not limited to, marshmallows and nougats. The confectionery products may also include hard confections (e.g., hard candies and tableted candies).

In some examples herein, a bulk sweetener composition of the present disclosure may be incorporated into a gelled (e.g., gummy) confection. Gelled confections may include the bulk sweetener composition and a gelling agent. The gelling agent may include, but is not limited to, gelatin, pectin, starch, dextrins, hydrocolloids, milk based proteins, and combinations thereof. Other ingredients may include, but are not limited to, colors, flavors, and polishing agents. A gelled confection of the present disclosure may be a reduced-sugar gelled confection. The sugar content may be reduced by at least 50%.

A traditional gelled confection, such as gummies or jellies, is typically made using a blend of sugar and corn syrup. A gelling agent (e.g., gelatin, pectin, starch, carrageenan, agar) may be used to set the product and to provide the desired texture attributes (e.g., elastic, chewy, short, etc.). The final moisture content of a gelled confection may range from about 15% to about 25% depending on desired texture. A typical sugar content per serving for gummies or jellies is 14 to 20 grams. Such traditional gelled confections may have a sugar content of 14 to 20 grams per 30 gram serving. A bulk sweetener composition of the present disclosure may be used in a gelled confection in place of traditional sugar and corn syrup blends and may provide 12 grams or less of sugar per 30 gram serving.

A reduced sugar gelled confection according to the present disclosure may include a bulk sweetener composition or a bulk phase replacement syrup. For example, a reduced sugar gelled confection may comprise the following ingredients by weight percent:

TABLE 11
Reduced Sugar Gelled Confection
with Bulk Phase Replacement Syrup

| Component | Lower | Upper |
|---|---|---|
| BULK PHASE REPLACEMENT SYRUP | 67.00% | 83.00% |
| WATER | 16.00% | 25.00% |
| GELLING AGENT (STARCH, GELATIN, | 1.00% | 12.00% |
| PECTIN, CARRAGEENAN, GELATIN, | | |
| AGAR, GUM ARABIC) | | |
| 50% ACID SOLUTION | QS | QS |
| COLOR (varies) | QS | QS |
| FLAVOR (varies) | QS | QS |
| POLISHING AGENT | QS | QS |

A reduced sugar gelled confection having the components listed in Table 11, may include from 67 wt. % to 83 wt. % of a bulk phase replacement syrup disclosed herein. The bulk phase replacement syrup may have a composition in accordance with the formulations shown in any one of Tables 6-10.

In some examples herein, a bulk sweetener composition of the present disclosure may be incorporated in a fruit chew. A traditional fruit chew is typically made using a blend of sugar and corn syrup. Fruit chews may be grained or ungrained and may include a gelling agent or hydrocolloid such as gelatin or gums. A fruit chew may also include a hard fat to prevent stickiness and improve stand-up. The final moisture content of a fruit chew may range from 4% to 12% depending on desired texture. A typical sugar content per serving for fruit chews is 15 to 20 grams. Such traditional fruit chews may have a sugar content of 15 to 20 grams per 30 gram serving. A bulk sweetener composition of the present disclosure may be used in a fruit chew composition in place of traditional sugar and corn syrup blends and may provide 12 grams or less of sugar per 30 gram serving.

A reduced sugar fruit chew according to the present disclosure may include a bulk sweetener composition or a bulk phase replacement syrup. For example, reduced sugar fruit chews may comprise the following ingredients by weight percent:

TABLE 12
Reduced Sugar Fruit Chews with Bulk Phase Replacement Syrup

| Component | Lower | Upper |
|---|---|---|
| BULK PHASE REPLACEMENT SYRUP | 67.75% | 91.90% |
| WATER | 4.00% | 12.00% |
| HYDROCOLLOID (PECTIN, CARRAGEENAN, | 0.25% | 6.00% |
| GELATIN, DEXTRIN, STARCH) | | |
| HARD FAT (PALM, COCONUT, | 3.50% | 12.00% |
| COCOA BUTTER, SHEA) | | |
| MONO & DIGLYCERIDES | 0.25% | 1.25% |
| LECITHIN | 0.10% | 1.00% |
| ACID (CITRIC, MALIC, FUMARIC, | QS | QS |
| ADIPIC, TARTARIC) | | |
| COLOR | QS | QS |
| FLAVOR | QS | QS |

A reduced sugar fruit chew having the components listed in Table 12, may include from 67.75 wt. % to 91.90 wt. % of a bulk phase replacement syrup disclosed herein. The bulk phase replacement syrup may have a composition in accordance with the formulations shown in any one of Tables 6-10.

In some examples herein, a bulk sweetener composition of the present disclosure may be incorporated in a nougat composition. Nougats may be flavored using fruit, nuts, or chocolate. A nougat may also include fat in the form of nut butter or pastes. Nougat density is typically aerated from 0.8 to 1.0 g/ml, and a final moisture content may range from 8% to 10%. A typical sugar content per serving for nougats is 16 to 20 grams. Such traditional nougats may have a sugar content of 16 to 20 grams per 30 gram serving. A bulk sweetener composition of the present disclosure may be used in a nougat composition in place of traditional sugar and corn syrup blends and may provide 12 grams or less of sugar per 30 gram serving.

A reduced sugar nougat according to the present disclosure may include a bulk sweetener composition or a bulk phase replacement syrup. For example, a reduced sugar nougat may comprise the following ingredients by weight percent:

TABLE 13
Reduced Sugar Nougat with Bulk Phase Replacement Syrup

| Component | Lower | Upper |
|---|---|---|
| BULK PHASE REPLACEMENT SYRUP | 80.00% | 89.00% |
| WATER | 8.00% | 11.00% |
| HYDROCOLLOID (PECTIN, CARRAGEENAN, | 0.00% | 2.00% |
| GELATIN, DEXTRIN, STARCH) | | |
| STABILIZER (ALBUMIN, SOY | 0.00% | 2.00% |
| PROTEIN, WHEY PROTEIN) | | |
| FAT | 3.00% | 5.00% |
| ACID | QS | QS |
| COLOR | QS | QS |
| FLAVOR | QS | QS |

A reduced sugar nougat having the components listed in Table 13, may include from 80 wt. % to 89 wt. % of a bulk phase replacement syrup disclosed herein. The bulk phase replacement syrup may have a composition in accordance with the formulations shown in any one of Tables 6-10.

In some examples herein, a bulk sweetener composition of the present disclosure may be incorporated in a marshmallow composition. A traditional marshmallow is typically made using a blend of sugar and corn syrup. Marshmallows may be grained or ungrained and may include a stabilizing agent such as gelatin and/or a protein to stabilize the foam structure. Marshmallows are typically aerated from 0.25 to 0.70 g/ml, depending on the desired final density. The final moisture content of a marshmallow may range from 5% to 18% depending on desired texture. A typical sugar content per serving for marshmallows is 15 to 20 grams. Such traditional marshmallows may have a sugar content of 15 to 20 grams per 30 gram serving. A bulk sweetener composition of the present disclosure may be used in a marshmallow composition in place of traditional sugar and corn syrup blends and may provide 12 grams or less of sugar per 30 gram serving.

A reduced sugar marshmallow according to the present disclosure may include a bulk sweetener composition or a bulk phase replacement syrup. For example, reduced marshmallows may comprise the following ingredients by weight percent:

TABLE 14
Reduced Sugar Marshmallows with Bulk Phase Replacement Syrup

| Component | Lower | Upper |
|---|---|---|
| BULK PHASE REPLACEMENT SYRUP | 75.00% | 93.50% |
| WATER | 5.00% | 18.00% |
| HYDROCOLLOID (PECTIN, CARRAGEENAN, | 1.50% | 5.00% |
| GELATIN, DEXTRIN, STARCH) | | |
| STABILIZER (ALBUMIN, | 0.00% | 2.00% |
| SOY PROTEIN, WHEY PROTEIN) | | |
| ACID (CITRIC, MALIC, | QS | QS |
| FUMARIC, ADIPIC, TARTARIC) | | |
| COLOR | QS | QS |
| FLAVOR | QS | QS |

A reduced sugar marshmallow having the components listed in Table 14, may include from 75 wt. % to 93.50 wt. % of a bulk phase replacement syrup disclosed herein. The bulk phase replacement syrup may have a composition in accordance with the formulations shown in any one of Tables 6-10.

In some examples herein, a bulk sweetener composition of the present disclosure may be incorporated in a caramel confection. A traditional caramel is typically made using a blend of sugar and corn syrup. Caramels may be distinctly different from other confectionery products due to the use of dairy ingredients to impart characteristic texture, color, and flavor. Caramels may include a gelling agent (e.g., gelatin, pectin, starch, carrageenan, or agar) to set the product and control cold flow in order to hold the shape of the product and resist flowing. Caramels may be brown or white, depending on the process conditions applied (e.g., atmospheric cooking vs. vacuum cooking). The final moisture content of caramel may range from 8% to 18% depending on desired texture and application. For instance, the final moisture content may vary between caramels that are in the form of cut, wrapped pieces and caramel fillings. A typical sugar content per serving for a caramel confection is 14 to 18 grams. Such traditional caramels may have a sugar content of 14 to 18 grams per 30 gram serving. A bulk sweetener composition of the present disclosure may be used in a caramel composition in place of traditional sugar and corn syrup blends and may provide 12 grams or less of sugar per 30 gram serving.

A reduced sugar caramel according to the present disclosure may include a bulk sweetener composition or a bulk phase replacement syrup. For example, reduced caramels may comprise the following ingredients by weight percent:

TABLE 15
Reduced Sugar Caramels with Bulk Phase Replacement Syrup

| Component | Lower | Upper |
|---|---|---|
| BULK PHASE REPLACEMENT SYRUP | 15.88% | 78.55% |
| WATER | 8.00% | 18.00% |
| HYDROCOLLOID (PECTIN, CARRAGEENAN, | 0.00% | 5.00% |
| GELATIN, STARCH) | | |
| DAIRY INGREDIENT (SWEETENED CONDENSED MILK, | 5.00% | 45.00% |
| CREAM, EVAPORATED MILK, DRIED WHOLE MILK, | | |
| NONFAT DRY MILK, CREAM, BUTTER) | | |
| HARD FAT | 8.00% | 15.00% |
| MONO & DIGLYCERIDES | 0.25% | 0.13% |
| LECITHIN | 0.00% | 0.50% |
| SALT | 0.20% | 0.50% |
| FLAVOR | QS | QS |

A reduced sugar caramel having the components listed in Table 15, may include from 15.88 wt. % to 78.55 wt. % of a bulk phase replacement syrup disclosed herein. The bulk phase replacement syrup may have a composition in accordance with the formulations shown in any one of Tables 6-10.

In some examples herein, a bulk sweetener composition of the present disclosure may be incorporated in a hard candy composition. A traditional hard candy is typically made using a blend of sugar and corn syrup. Hard candies may include colors and flavors. In some examples, a hard candy may be fruit-flavored. Fruit-flavored hard candies may include acid to enhance flavor. The final moisture content of a hard candy may range from 1% to 3%. A typical sugar content per serving for a hard candy is 22 to 27 grams. Such traditional hard candies may have a sugar content of 22 to 27 grams per 30 gram serving. A bulk sweetener composition of the present disclosure may be used in a hard candy formulation in place of traditional sugar and corn syrup blends and may provide 12 grams or less of sugar per 30 gram serving.

A reduced sugar hard candy according to the present disclosure may include a bulk sweetener composition or a bulk phase replacement syrup. For example, reduced sugar hard candies may comprise the following ingredients by weight percent:

TABLE 16
Reduced Sugar Hard Candy with Bulk Phase Replacement Syrup

| Component | Lower | Upper |
|---|---|---|
| BULK PHASE REPLACEMENT SYRUP | 94.00% | 98.75% |
| WATER | 1.00% | 3.00% |
| ACID | 0.00% | 2.00% |
| COLOR | 0.10% | 0.50% |
| FLAVOR | 0.15% | 0.50% |

A reduced sugar hard candy having the components listed in Table 16, may include from 94 wt. % to 98.75 wt. % of a bulk phase replacement syrup disclosed herein. The bulk phase replacement syrup may have a composition in accordance with the formulations shown in any one of Tables 6-10.

The bulk sweetener compositions of the present disclosure may be capable of replacing traditional sucrose and corn syrup blends in a variety of confections and reducing the sugar content, while providing taste, texture, and colligative properties that are comparable to the traditional blends, without the use of polyols. Compositions disclosed herein may be free from polyols or sugar alcohols. Compositions disclosed herein may also be free from high intensity sweeteners.

The following examples are intended to illustrate the present disclosure without, however, being limiting in nature. It is understood that the present disclosure encompasses additional embodiments consistent with the foregoing description and following examples.

### EXAMPLES

### Example 1A

A reduced sugar gummy formulation comprising 13 g of sugar per 30 g serving compared to a gummy formulation comprising approximately 20 g of sugar per 30 g serving was prepared by combining the bulk phase and other ingredients shown in Table 17.

TABLE 17
Reduced Sugar Gummies with Maltodextrin

| | w/w |
|---|---|
| Bulk Phase | |
| HIGH MALTOSE CORN SYRUP, | 39.06% |
| 42DE | |
| MALTODEXTRIN, 10 DE | 8.15% |
| SUCROSE | 23.12% |
| WATER | 19.00% |
| Other Ingredients | |
| MODIFIED CORN STARCH | 5.00% |
| GELATIN, 250 BLOOM | 4.00% |
| 50% ACID SOLUTION | 1.31% |
| COLOR (varies) | QS |
| FLAVOR (varies) | QS |
| POLISHING AGENT | 0.15% |
| | 100.00% |

### Example 1B

A reduced sugar gummy formulation comprising 13 g of sugar per 30 g serving compared to a gummy formulation comprising approximately 20 g of sugar per 30 g serving was prepared by combining the bulk phase and other ingredients shown in Table 18.

TABLE 18
Reduced Sugar Gummies with Resistant Maltodextrin

| | w/w |
|---|---|
| Bulk Phase | |
| HIGH MALTOSE CORN SYRUP, | 40.75% |
| 42 DE | |
| RESISTANT MALTODEXTRIN | 7.24% |
| SUGAR | 22.36% |
| WATER | 19.00% |
| Other Ingredients | |
| MODIFIED CORN STARCH | 5.00% |
| GELATIN, 250 BLOOM | 4.00% |
| 50% ACID SOLUTION | 1.31% |
| COLOR (varies) | 0.02% |
| FLAVOR (varies) | 0.18% |
| POLISHING AGENT | 0.15% |
| | 100.00% |

### Example 1C

A reduced sugar gummy formulation comprising 13 g of sugar per 30 g serving compared to a gummy formulation comprising approximately 20 g of sugar per 30 g serving was prepared by combining the bulk phase and other ingredients shown in Table 19.

TABLE 19
Reduced Sugar Gummies with Allulose

| | w/w |
|---|---|
| Bulk Phase | |
| HIGH MALTOSE CORN SYRUP, | 38.83% |
| 42 DE | |
| ALLULOSE | 8.53% |
| SUGAR | 22.98% |
| WATER | 19.00% |
| Other Ingredients | |
| MODIFIED CORN STARCH | 5.00% |
| GELATIN, 250 BLOOM | 4.00% |
| 50% ACID SOLUTION | 1.31% |
| COLOR (varies) | QS |
| FLAVOR (varies) | QS |
| POLISHING AGENT | 0.15% |
| | 100.00% |

### Example 2A

A reduced sugar gummy formulation comprising 10 g of sugar per 30 g serving compared to a gummy formulation comprising approximately 20 g of sugar per 30 g serving was prepared by combining the bulk phase and other ingredients shown in Table 20.

TABLE 20
Reduced Sugar Gummies with Allulose

| | w/w |
|---|---|
| Bulk Phase | |
| HIGH MALTOSE CORN | 40.26% |
| SYRUP, 42 DE | |
| MALTODEXTRIN | 12.61% |
| ALLULOSE | 7.74% |
| SUGAR | 11.69% |
| WATER | 17.00% |
| Other Ingredients | |
| MODIFIED CORN STARCH | 5.00% |
| GELATIN, 250 BLOOM | 4.00% |
| 50% ACID SOLUTION | 1.34% |
| COLOR (varies) | QS |
| FLAVOR (varies) | QS |
| POLISHING AGENT | 0.15% |
| | 100.00% |

### Example 2B

A reduced sugar gummy formulation comprising 10 g of sugar per 30 g serving compared to a gummy formulation comprising approximately 20 g of sugar per 30 g serving was prepared by combining the bulk phase and other ingredients shown in Table 21.

TABLE 21
Reduced Sugar Gummies with Allulose

| | w/w |
|---|---|
| Bulk Phase | |
| HIGH MALTOSE CORN | 39.79% |
| SYRUP, 42 DE | |
| ALLULOSE | 20.40% |
| SUGAR | 12.12% |
| WATER | 17.00% |
| Other Ingredients | |
| MODIFIED CORN STARCH | 5.00% |
| GELATIN, 250 BLOOM | 4.00% |
| 50% ACID SOLUTION | 1.34% |
| COLOR (varies) | QS |
| FLAVOR (varies) | QS |
| POLISHING AGENT | 0.15% |
| | 100.00% |

### Example 2C

A reduced sugar gummy formulation comprising 10 g of sugar per 30 g serving compared to a gummy formulation comprising approximately 20 g of sugar per 30 g serving was prepared by combining the bulk phase and other ingredients shown in Table 22.

TABLE 22
Reduced Sugar Gummies

| | w/w |
|---|---|
| Bulk Phase | |
| HIGH MALTOSE CORN | 39.68% |
| SYRUP, 42 DE | |
| RESISTANT MALTODEXRIN | 20.69% |
| FRUCTOSE | 5.00% |
| SUGAR | 6.93% |
| WATER | 17.00% |
| Other Ingredients | |
| MODIFIED STARCH | 4.00% |
| GELATIN, 250 BLOOM | 5.00% |
| 50% ACID SOLUTION | 1.34% |
| COLOR (varies) | QS |
| FLAVOR (varies) | QS |
| POLISHING AGENT | 0.15% |
| | 100.00% |

### Example 3

A reduced sugar gummy formulation comprising 7 g of sugar per 30 g serving compared to a gummy formulation comprising approximately 20 g of sugar per 30 g serving was prepared by combining the bulk phase and other ingredients shown in Table 23.

TABLE 23
Reduced Sugar Plant Based Gummies

| | w/w |
|---|---|
| Bulk Phase | |
| HIGH MALTOSE CORN | 12.50% |
| SYRUP, 42 DE | |
| RESISTANT MALTODEXRIN | 52.90% |
| FRUCTOSE | 5.65% |
| SUGAR | 8.25% |
| WATER | 16.00% |
| Other Ingredients | |
| PECTIN | 2.00% |
| POTASSUM CITRATE | 0.6% |
| 50% ACID SOLUTION | 1.34% |
| COLOR (varies) | QS |
| FLAVOR (varies) | QS |
| POLISHING AGENT | 0.15% |
| | 100.00% |

### Example 4

A reduced sugar gummy formulation comprising 5 g of sugar per 30 g serving compared to a gummy formulation comprising approximately 20 g of sugar per 30 g serving was prepared by combining the bulk phase and other ingredients shown in Table 24.

TABLE 24
Reduced Sugar Plant Based Gummies with Allulose

| | w/w |
|---|---|
| Bulk Phase | |
| RESISTANT MALTODEXTRIN | 24.90% |
| MALTODEXTRIN | 13.87% |
| ALLULOSE | 21.83% |
| SUGAR | 10.61% |
| FRUIT JUICE CONCENTRATE (70° | 5.50% |
| BRIX) | |
| WATER | 16.00% |
| Other Ingredients | |
| NATIVE TAPIOCA STARCH | 3.25% |
| PECTIN | 2.00% |
| 50% ACID SOLUTION | 1.34% |
| SODIUM CITRATE | 0.20% |
| COLOR (varies) | QS |
| FLAVOR (varies) | QS |
| POLISHING AGENT | 0.15% |
| | 100.00% |

### Example 5

A reduced sugar gummy formulation comprising 12 g of sugar per 30 g serving was prepared with the ingredients shown in Table 25.

TABLE 25
Reduced Sugar Gummy: 12 g sugar per serving

| Component | w/w |
|---|---|
| CORN SYRUP, 42DE | 15.41% |
| SOLUBLE FIBER | 26.92% |
| SUGAR | 28.42% |
| WATER | 19.00% |
| MODIFIED CORN STARCH | 5.00% |
| GELATIN | 4.00% |
| 50% ACID SOLUTION | 1.30% |
| COLOR (varies) | QS |
| FLAVOR (varies) | QS |
| POLISHING AGENT | 0.15% |
| | 100.00% |

### Example 6

A reduced sugar gummy formulation comprising 9 g of sugar per 30 g serving was prepared with the ingredients shown in Table 26.

TABLE 26
Reduced Sugar Gummy: 9 g sugar per serving

| Component | w/w |
|---|---|
| CORN SYRUP, 42 DE | 39.01% |
| ALLULOSE | 20.99% |
| SUGAR | 10.89% |
| WATER | 19.00% |
| MODIFIED CORN STARCH | 5.00% |
| GELATIN, 250 BLOOM | 4.00% |
| 50% ACID SOLUTION | QS |
| COLOR (varies) | QS |
| FLAVOR (varies) | QS |
| POLISHING AGENT | 0.15% |
| | 100.00% |

### Example 7

A reduced sugar gummy formulation comprising 10 g of sugar per 30 g serving was prepared with the ingredients shown in Table 27.

TABLE 27
Reduced Sugar Gummy: 10 g sugar per serving

| Component | w/w |
|---|---|
| CORN SYRUP 42DE | 39.20% |
| SOLUBLE FIBER | 20.44% |
| SUGAR | 11.78% |
| WATER | 18.00% |
| MODIFIED CORN STARCH | 3.95% |
| GELATIN, 250 BLOOM | 4.94% |
| 50% ACID SOLUTION | 1.30% |
| COLOR (varies) | QS |
| FLAVOR (varies) | QS |
| POLISHING AGENT | 0.15% |
| | 100.00% |

### Example 8

A reduced sugar gummy formulation comprising 8 g of sugar per 30 g serving was prepared with the ingredients shown in Table 28.

TABLE 28
Reduced Sugar Plant-Based Gummy: 8 g sugar per serving

| Component | w/w |
|---|---|
| CORN SYRUP, 42DE | 12.29% |
| SOLUBLE FIBER | 46.99% |
| FRUCTOSE | 5.33% |
| SUGAR | 12.73% |
| WATER | 18.00% |
| PECTIN DJ 150 | 2.25% |
| CITRIC ACID | 0.12% |
| SODIUM CITRATE | 0.38% |
| TRIPOTASSIUM CITRATE | 0.25% |
| 50% ACID SOLUTION | 1.30% |
| COLOR (varies) | QS |
| FLAVOR (varies) | QS |
| POLISHING AGENT | 0.15% |
| | 100.00% |

### Example 9

A reduced sugar gummy formulation comprising 5 g of sugar per 30 g serving was prepared with the ingredients shown in Table 29.

TABLE 29
Reduced Sugar Plant-Based Gummy: 5 g sugar per serving

| Component | w/w |
|---|---|
| SOLUBLE FIBER | 36.84% |
| ALLULOSE | 23.43% |
| SUGAR | 10.36% |
| FRUIT JUICE CONCENTRATE (70 Brix) | 5.16% |
| WATER | 18.00% |
| TAPIOCA STARCH | 2.16% |
| PECTIN | 1.91% |
| POTASSIUM CITRATE | 0.42% |
| SODIUM CITRATE | 0.26% |
| 50% ACID SOLUTION | 1.30% |
| COLOR (varies) | QS |
| FLAVOR (varies) | QS |
| POLISHING AGENT | 0.15% |
| | 100.00% |

### Example 10A

A reduced sugar gummy formulation comprising 3 g of sugar per 30 g serving was prepared with the ingredients shown in Table 30.

TABLE 30
Reduced Sugar Gummy: 3 g sugar per serving

| Component | w/w |
|---|---|
| SOLUBLE FIBER SYRUP | 43.02% |
| ALLULOSE | 23.67% |
| FRUIT JUICE CONCENTRATE, BRIX | 5.41% |
| SUGAR | 4.50% |
| WATER | 18.00% |
| MODIFIED CORN STARCH | 4.62% |
| GELATIN | 3.69% |
| 50% ACID SOLUTION | 1.30% |
| Color Solution (varies) | QS |
| Flavor (varies) | QS |
| STEVIA EXTRACT | 0.020% |
| POLISHING AGENT | 0.15% |
| | 100.00% |

### Example 10B

A reduced sugar gummy formulation comprising 3 g of sugar per 30 g serving was prepared with the ingredients shown in Table 31.

TABLE 31
Reduced Sugar Plant Based Gummy: 3 g sugar per serving

| Component | w/w |
|---|---|
| SOLUBLE FIBER SYRUP | 46.69% |
| ALLULOSE | 23.89% |
| FRUIT JUICE CONCENTRATE, 70 BRIX | 5.72% |
| SUGAR | 4.30% |
| WATER | 18.00% |
| TAPIOCA STARCH | 2.00% |
| PECTIN | 2.00% |
| 50% ACID SOLUTION | 1.31% |
| Color Solution (varies) | QS |
| Flavor (varies) | QS |
| STEVIA EXTRACT | 0.020% |
| POLISHING AGENT | 0.152% |
| | 100.00% |

### Example 11

A reduced sugar gummy formulation comprising less than 0.5 g of sugar per 30 g serving was prepared with the ingredients shown in Table 32.

TABLE 32
No Sugar Added Gummy: <0.5 g sugar per serving

| Component | w/w |
|---|---|
| SOLUBLE FIBER | 47.10% |
| ALLULOSE | 24.23% |
| WATER | 18.00% |
| MODIFIED STARCH | 5.00% |
| GELATIN | 4.00% |
| 50% ACID SOLUTION | 1.31% |
| Color Solution (varies) | QS |
| Flavor (varies) | QS |
| STEVIA EXTRACT | 0.020% |
| POLISHING AGENT | 0.150% |
| | 100.00% |

### Example 12

A reduced sugar fruit chew formulation comprising 11 g of sugar per 30 g serving was prepared with the ingredients shown in Table 33.

TABLE 33
Reduced Sugar Fruit Chew: 11 g Sugar per Serving

| Component | w/w |
|---|---|
| SOLUBLE FIBER | 43.915% |
| FRUCTOSE | 13.680% |
| SUCROSE | 27.753% |
| WATER | 6.00% |
| PECTIN | 1.05% |
| MODIFIED POTATO STARCH | 3.795% |
| HYDROGENATED PALM KERNEL OIL | 6.95% |
| MONO & DIGLYCERIDES | 0.63% |
| LECITHIN | 0.17% |
| CITRIC ACID | QS |
| COLOR | QS |
| FLAVOR | QS |
| 6X SUGAR | 6.147% |
| | 100.000% |

### Example 13

A reduced sugar fruit chew formulation comprising 8 g of sugar per 30 g serving was prepared with the ingredients shown in Table 34.

TABLE 34
Reduced Sugar Fruit Chew: 8 g Sugar per Serving

| Component | w/w |
|---|---|
| SOLUBLE FIBER | 33.384% |
| ALLULOSE | 20.736% |
| SUCROSE | 13.036% |
| WATER | 6.000% |
| PECTIN | 0.781% |
| MODIFIED POTATO STARCH | 3.795% |
| HYDROGENATED PALM KERNEL OIL | 7.022% |
| MONO & DIGLYCERIDES | 0.638% |
| LECITHIN | 0.170% |
| CITRIC ACID | QS |
| COLOR | QS |
| FLAVOR | QS |
| 6X SUGAR | 12.335% |
| | 100.000% |

### Example 14

A reduced sugar fruit chew formulation comprising 5 g of sugar per 30 g serving was prepared with the ingredients shown in Table 35.

TABLE 35
Reduced Sugar Fruit Chew: 5 g sugar per serving

| Component | w/w |
|---|---|
| SOLUBLE FIBER | 39.907% |
| ALLULOSE | 24.695% |
| FRUIT JUICE CONCENTRATE | 5.50% |
| WATER | 6.000% |
| PECTIN | 0.523% |
| MODIFIED POTATO STARCH | 3.795% |
| HYDROGENATED PALM KERNEL OIL | 6.957% |
| MONO & DIGLYCERIDES | 0.632% |
| LECITHIN | 0.169% |
| CITRIC ACID | 1.687% |
| COLOR | 0.008% |
| FLAVOR | 0.202% |
| 6X SUGAR | 9.924% |
| | 100.000% |

### Example 15

A reduced sugar fruit chew formulation comprising 3 g of sugar per 30 g serving was prepared with the ingredients shown in Table 36.

TABLE 36
Reduced Sugar Fruit Chew: 3 g Sugar per Serving

| Component | w/w |
|---|---|
| SOLUBLE FIBER | 49.112% |
| ALLULOSE | 24.236% |
| WATER | 6.000% |
| PECTIN | 0.527% |
| MODIFIED POTATO STARCH | 3.795% |
| HARD FAT | 7.007% |
| MONO & DIGLYCERIDES | 0.637% |
| LECITHIN | 0.170% |
| CITRIC ACID | QS |
| COLOR | QS |
| FLAVOR | QS |
| 6X SUGAR | 6.579% |
| | 100.000% |

### Example 16

A reduced sugar fruit chew formulation comprising less than 0.5 g of sugar per 30 g serving was prepared with the ingredients shown in Table 37.

TABLE 37
No Sugar Added Fruit Chew: <0.5 g sugar per serving

| Component | w/w |
|---|---|
| SOLUBLE FIBER | 55.237% |
| ALLULOSE | 23.527% |
| SUCROSE | 0.000% |
| WATER | 6.000% |
| PECTIN | 0.570% |
| MODIFIED POTATO STARCH | 3.795% |
| HARD FAT | 7.586% |
| MONO & DIGLYCERIDES | 0.690% |
| LECITHIN | 0.184% |
| CITRIC ACID | QS |
| COLOR | QS |
| FLAVOR | QS |
| STEVIA OR MONKFRUIT EXTRACT | 0.02% |
| | 100.000% |

### Example 17

A reduced sugar nougat formulation comprising 12 g of sugar per 30 g serving was prepared with the ingredients shown in Table 38.

TABLE 38
Reduced Sugar Chewy Nougat: 12 g sugar per serving

| Component | w/w |
|---|---|
| SOLUBLE FIBER | 47.21% |
| FRUCTOSE | 2.36 |
| SUGAR | 33.01% |
| PROTEIN (ALBUMIN) | 1.41% |
| WATER | 10.00% |
| SUGAR | 3.24% |
| FAT | 3.24% |
| COLOR (varies) | QS |
| FLAVOR (varies) | QS |
| ACID | QS |
| | 100.000% |

### Example 18

A reduced sugar nougat formulation comprising 12 g of sugar per 30 g serving was prepared with the ingredients shown in Table 39.

TABLE 39
Reduced Sugar Soft Nougat: 12 g sugar per serving

| Component | w/w |
|---|---|
| SOLUBLE FIBER | 43.553% |
| INVERT SUGAR | 2.923% |
| SUGAR | 26.139% |
| WATER | 10.00% |
| PROTEIN | 1.037% |
| COCOA POWDER | 3.910% |
| COCOA BUTTER | 5.013% |
| SALT | 0.334% |
| FLAVOR | 0.201% |
| 6X SUGAR | 6.096% |
| | 100.000% |

### Example 19

A reduced sugar nougat formulation comprising 8 g of sugar per 30 g serving was prepared with the ingredients shown in Table 40.

TABLE 40
Reduced Sugar Soft Nougat: 8 g sugar per serving

| Component | w/w |
|---|---|
| SOLUBLE FIBER | 37.149% |
| ALLULOSE | 16.641% |
| SUCROSE | 14.561% |
| WATER | 10.00% |
| PROTEIN | 1.033% |
| COCOA POWDER | 3.896% |
| COCOA BUTTER | 4.995% |
| SALT | 0.333% |
| FLAVOR | 0.200% |
| 6X SUGAR | 10.401% |
| | 100.000% |

### Example 20

A reduced sugar nougat formulation comprising 5 g of sugar per 30 g serving was prepared with the ingredients shown in Table 41.

TABLE 41
Reduced Sugar Soft Nougat: 5 g sugar per serving

| Component | w/w |
|---|---|
| SOLUBLE FIBER | 41.103% |
| ALLULOSE | 20.724% |
| SUCROSE | 5.181% |
| WATER | 14.507% |
| PROTEIN | 0.974% |
| COCOA POWDER | 3.592% |
| FAT | 4.145% |
| SALT | 0.276% |
| FLAVOR | 0.207% |
| 6X SUGAR | 8.635% |
| | 100.000% |

### Example 21

A reduced sugar nougat formulation comprising 3 g of sugar per 30 g serving was prepared with the ingredients shown in Table 42.

TABLE 42
Reduced Sugar Soft Nougat: 3 g sugar per serving

| Component | w/w |
|---|---|
| SOLUBLE FIBER | 43.906% |
| ALLULOSE | 23.994% |
| SUCROSE | 0.000% |
| WATER | 10.00% |
| PROTEIN | 1.045% |
| CARRAGEENAN | 1.038% |
| COCOA POWDER | 3.942% |
| COCOA BUTTER | 5.054% |
| SALT | 0.337% |
| FLAVOR | 0.202% |
| 6X SUGAR | 9.682% |
| STEVIA EXTRACT | 0.020% |
| | 100.000% |

### Example 22

A reduced sugar marshmallow comprising 12 g of sugar per 30 g serving was prepared with the ingredients shown in Table 43.

TABLE 43
Reduced Sugar Marshmallow: 12 g sugar per serving

| Component | w/w |
|---|---|
| SOLUBLE FIBER | 35.44% |
| SUGAR | 36.39% |
| FRUCTOSE | 2.35% |
| WATER | 20.00% |
| MODIFIED STARCH | 2.50% |
| GELATIN | 2.00% |
| ACID | QS |
| COLOR (varies) | QS |
| FLAVOR (varies) | QS |
| | 100.00% |

### Example 23

A reduced sugar marshmallow comprising 9 g of sugar per 30 g serving was prepared with the ingredients shown in Table 44.

TABLE 44
Reduced Sugar Marshmallow: 9 g sugar per serving

| Component | w/w |
|---|---|
| SOLUBLE FIBER | 34.34% |
| SUGAR | 28.44% |
| ALLULOSE | 11.43% |
| WATER | 20.000% |
| MODIFIED STARCH | 2.50% |
| GELATIN | 2.00% |
| ACID | QS |
| COLOR (varies) | QS |
| FLAVOR (varies) | QS |
| | 100.00% |

### Example 24

A reduced sugar marshmallow comprising 7 g of sugar per 30 g serving was prepared with the ingredients shown in Table 45.

TABLE 45
Reduced Sugar Marshmallow: 7 g sugar per serving

| Component | w/w |
|---|---|
| SOLUBLE FIBER | 51.80% |
| SUGAR | 18.93% |
| FRUCTOSE | 3.43% |
| WATER | 20.000% |
| MODIFIED STARCH | 2.50% |
| GELATIN | 2.00% |
| ACID | QS |
| COLOR (varies) | QS |
| FLAVOR (varies) | QS |
| | 100.00% |

### Example 25

A reduced sugar marshmallow comprising 5 g of sugar per 30 g serving was prepared with the ingredients shown in Table 46.

TABLE 46
Reduced Sugar Marshmallow: 5 g sugar per serving

| Component | w/w |
|---|---|
| SOLUBLE FIBER | 34.32% |
| SUGAR | 17.05% |
| ALLULOSE | 22.85% |
| WATER | 20.000% |
| MODIFIED STARCH | 2.50% |
| GELATIN | 2.00% |
| ACID | QS |
| COLOR (varies) | QS |
| FLAVOR (varies) | QS |
| | 100.00% |

### Example 26

A reduced sugar marshmallow comprising 3 g of sugar per 30 g serving was prepared with the ingredients shown in Table 47.

TABLE 47
Reduced Sugar Marshmallow: 3 g sugar per serving

| Component | w/w |
|---|---|
| SOLUBLE FIBER | 42.84% |
| ALLULOSE | 23.65% |
| SUGAR | 7.69% |
| WATER | 20.000% |
| MODIFIED STARCH | 2.50% |
| GELATIN | 2.00% |
| ACID | QS |
| COLOR (varies) | QS |
| FLAVOR (varies) | QS |
| STEVIA OR MONKFRUIT EXTRACT | 0.02% |
| | 100.00% |

### Example 27

A reduced sugar marshmallow comprising less than 0.5 g of sugar per 30 g serving was prepared with the ingredients shown in Table 48.

TABLE 48
No Sugar Added Marshmallow: <0.5 g sugar per serving

| Component | w/w |
|---|---|
| SOLUBLE FIBER | 50.55% |
| ALLULOSE | 23.62% |
| WATER | 20.000% |
| MODIFIED STARCH | 2.50% |
| GELATIN | 2.00% |
| ACID | QS |
| COLOR (varies) | QS |
| FLAVOR (varies) | QS |
| STEVIA OR MONKFRUIT EXTRACT | 0.02% |
| | 100.00% |

### Example 28

A reduced sugar caramel comprising 11 g of sugar per 30 g serving was prepared with the ingredients shown in Table 49.

TABLE 49
Reduced Sugar Caramel: 11 g sugar per serving

| Component | w/w |
|---|---|
| SOLUBLE FIBER | 36.39% |
| SUGAR | 15.53% |
| FRUCTOSE | 4.01% |
| WATER | 10.00% |
| CARRAGEENAN | 1.28% |
| SWEETENED CONDENSED MILK | 22.20% |
| HARD FAT | 9.69% |
| MONO & DIGLYCERIDES | 0.44% |
| LECITHIN | 0.12% |
| SALT | 0.34% |
| | 100.000% |

### Example 29A

A reduced sugar caramel comprising 8 g of sugar per 30 g serving was prepared with the ingredients shown in Table 50.

TABLE 50
Reduced Sugar Caramel: 8 g sugar per serving

| Component | w/w |
|---|---|
| SOLUBLE FIBER | 44.49% |
| SUGAR | 17.10% |
| FRUCTOSE | 2.95% |
| WATER | 12.00% |
| CARRAGEENAN | 1.03% |
| EVAPORATED MILK | 11.69% |
| HARD FAT | 9.74% |
| MONO & DIGLYCERIDES | 0.52% |
| LECITHIN | 0.14% |
| SALT | 0.34% |
| | 100.000% |

### Example 29B

A reduced sugar caramel comprising 8 g of sugar per 30 g serving was prepared with the ingredients shown in Table 51.

TABLE 51
Reduced Sugar Fruit Caramel: 8 g Sugar per Serving

| Component | w/w |
|---|---|
| SOLUBLE FIBER | 45.26% |
| SUGAR | 15.08% |
| FRUIT JUICE CONCENTRATE | 5.80% |
| WATER | 10.00% |
| PECTIN | 1.05% |
| EVAPORATED MILK | 11.89% |
| HARD FAT | 9.91% |
| MONO & DIGLYCERIDES | 0.52% |
| LECITHIN | 0.14% |
| CITRIC ACID | 0.50% |
| COLOR | QS |
| FLAVOR | QS |
| | 100.000% |

### Example 30

A reduced sugar caramel comprising 5 g of sugar per 30 g serving was prepared with the ingredients shown in Table 52.

TABLE 52
Reduced Sugar Caramel: 5 g sugar per serving

| Component | Finished w/w |
|---|---|
| SOLUBLE FIBER | 36.10% |
| ALLULOSE | 19.35% |
| WATER | 10.00% |
| CARRAGEENAN | 0.98% |
| SWEETENED CONDENSED MILK | 23.02% |
| HARD FAT | 9.67% |
| MONO & DIGLYCERIDES | 0.44% |
| LECITHIN | 0.12% |
| SALT | 0.32% |
| | 100.000% |

### Example 31

A reduced sugar caramel comprising 3 g of sugar per 30 g serving was prepared with the ingredients shown in Table 53.

TABLE 53
Reduced Sugar Caramel: 3 g sugar per serving

| Component | w/w |
|---|---|
| SOLUBLE FIBER | 46.32% |
| SUGAR | 3.56% |
| ALLULOSE | 14.32% |
| WATER | 12.00% |
| CARRAGEENAN | 1.07% |
| EVAPORATED MILK | 12.17% |
| HARD FAT | 9.54% |
| MONO & DIGLYCERIDES | 0.54% |
| LECITHIN | 0.14% |
| SALT | 0.33% |
| STEVIA OR MONKFRUIT EXTRACT | 0.02% |
| | 100.000% |

### Example 32

A reduced sugar hard candy comprising 17 g of sugar per 30 g serving was prepared with the ingredients shown in Table 54.

TABLE 54
Reduced Sugar Hard Candy: 17 g sugar per serving

| Component | w/w |
|---|---|
| 42 DE CORN SYRUP | 17.226% |
| SOLUBLE FIBER | 31.223% |
| INVERT SUGAR | 1.435% |
| SUCROSE | 53.806% |
| WATER | 2.00% |
| CITRIC ACID | 1.00% |
| COLOR | QS |
| FLAVOR | QS |
| | 100.00% |

### Example 33

A reduced sugar hard candy comprising 12 g of sugar per 30 g serving was prepared with the ingredients shown in Table 55.

TABLE 55
Reduced Sugar Hard Candy: 12 g sugar per serving

| Component | w/w |
|---|---|
| SOLUBLE FIBER | 45.170% |
| INVERT SUGAR | 2.875% |
| SUCROSE | 35.938% |
| WATER | 2.00% |
| CITRIC ACID | 1.000% |
| COLOR | QS |
| FLAVOR | QS |
| | 100.000% |

### Example 34

A reduced sugar hard candy comprising 8 g of sugar per 30 g serving was prepared with the ingredients shown in Table 56.

TABLE 56
Reduced Sugar Hard Candy: 8 g sugar per serving

| Component | w/w |
|---|---|
| SOLUBLE FIBER | 58.008% |
| ALLULOSE | 11.695% |
| SUCROSE | 26.899% |
| WATER | 2.00% |
| CITRIC ACID | 1.000% |
| COLOR | QS |
| FLAVOR | QS |
| | 100.000% |

### Example 35

A reduced sugar hard candy comprising 5 g of sugar per 30 g serving was prepared with the ingredients shown in Table 57.

TABLE 57
Reduced Sugar Hard Candy: 5 g sugar per serving

| Component | w/w |
|---|---|
| SOLUBLE FIBER | 58.008% |
| ALLULOSE | 23.390% |
| SUCROSE | 15.204% |
| WATER | 2.00% |
| CITRIC ACID | 1.000% |
| COLOR | QS |
| FLAVOR | QS |
| | 100.000% |

### Example 36

A reduced sugar hard candy comprising 3 g of sugar per 30 g serving was prepared with the ingredients shown in Table 58.

TABLE 58
Reduced Sugar Hard Candy: 3 g sugar per serving

| Component | w/w |
|---|---|
| SOLUBLE FIBER | 58.008% |
| ALLULOSE | 23.390% |
| SUCROSE | 15.204% |
| WATER | 2.00% |
| CITRIC ACID | 1.000% |
| COLOR | QS |
| FLAVOR | QS |
| | 100.000% |

It should be noted that although various examples are described, the present disclosure is not limited to these examples. Other aspects and embodiments of the present disclosure will be apparent to those skilled in the art from consideration of the specification and practice of the embodiments disclosed herein. It is intended that the specification and examples be considered as exemplary only, with a true scope and spirit of the present disclosure being indicated by the following claims.

1. A bulk sweetener composition comprising:
at least one of a glucose syrup, a soluble fiber, and maltodextrin; and
at least one of a monosaccharide, a disaccharide, and a low calorie monosaccharide.

2. The bulk sweetener composition of claim 1, wherein the bulk sweetener composition does not comprise a polyol or a high intensity sweetener.

3. The bulk sweetener composition of claim 1, wherein the bulk sweetener composition comprises:
a glucose syrup in an amount from about 0% to about 53% by weight, based on the total weight of the bulk sweetener composition;
a disaccharide in an amount from about 25% to about 47% by weight, based on the total weight of the bulk sweetener composition; and
a low calorie monosaccharide in an amount from about 0% to about 12% by weight, based on the total weight of the bulk sweetener composition.

4. The bulk sweetener composition of claim 3, wherein the low calorie monosaccharide is allulose.

5. The bulk sweetener composition of claim 3, wherein the bulk sweetener composition further comprises:
maltodextrin in an amount from about 0% to about 12% by weight, based on the total weight of the bulk sweetener composition.

6. The bulk sweetener composition of claim 3, wherein the bulk sweetener composition further comprises:
a soluble fiber in an amount from about 0% to about 10% by weight, based on the total weight of the bulk sweetener composition.

7. The bulk sweetener composition of claim 6, wherein the soluble fiber is resistant maltodextrin.

8. A confectionery composition comprising:
a bulk sweetener composition, wherein the bulk sweetener composition comprises
at least one of a glucose syrup, a soluble fiber, and maltodextrin; and
at least one of a monosaccharide, a disaccharide, and a low calorie monosaccharide;
wherein the bulk sweetener composition provides for at least 33% sugar reduction in the confectionery composition.

9. (canceled)

10. The confectionery composition of claim 8, wherein the bulk sweetener composition is free from polyols.

11. The confectionery composition of claim 8, wherein the low calorie monosaccharide is allulose, tagatose, or a combination thereof.

12. The confectionery composition of claim 8, wherein the disaccharide is sucrose, maltose, lactose, trehalose, or a combination thereof.

13. The confectionery composition of claim 8, wherein the monosaccharide is fructose, glucose, or a combination thereof.

14. The confectionery composition of claim 8, wherein the bulk sweetener composition comprises soluble fiber.

15. (canceled)

16. The confectionery composition of claim 8, wherein the glucose syrup is a high maltose corn syrup.

17. The confectionery composition of claim 8, wherein the bulk sweetener composition comprises soluble fiber, glucose syrup, a monosaccharide, and a disaccharide.

18-19. (canceled)

20. The confectionery composition of claim 8, wherein the bulk sweetener composition provides for at least 50% sugar reduction in the confectionery composition.

21. A reduced sugar gelled confection comprising:
a gelling agent comprising gelatin, pectin, starch, hydrocolloids, or combinations thereof; and
a bulk sweetener composition comprising at least one of a glucose syrup, a soluble fiber, and maltodextrin; and
at least one of a monosaccharide, a disaccharide, and a low calorie monosaccharide selected from allulose and tagatose;
wherein the gelled confection is free from polyols.

22. The reduced sugar gelled confection of claim 21, wherein the gelled confection has a texture similar to that of a gelled confection comprising corn syrup to sucrose at a ratio of 55:45 wt. % solids.

23. The reduced sugar gelled confection of claim 21, wherein the bulk sweetener composition comprises a monosaccharide in the form of fructose and a disaccharide in the form of sucrose.

24-28. (canceled)

29. The reduced sugar gelled confection of claim 21, wherein the reduced sugar gelled confection comprises 12 grams or less of sugar per 30 gram serving.
